(19) United States
(12) Patent Application Publication
(10) Pub. No.: US 2025/0345713 A1
(43) Pub. Date: Nov. 13, 2025

(54) USE OF A POLYURETHANE COATING FOR MAINTENANCE AND REPAIR OF WATERSLIDES

(71) Applicant: PORVIVA BV, Heerlen (NL)

(72) Inventors: Stefan Andreas Krayer, Langenfeld (DE); Tim Peter Pleyers, Würselen (DE); Gerd Josef Pleyers, Würselen (DE)

(21) Appl. No.: 19/107,376

(22) PCT Filed: Aug. 23, 2023
(86) PCT No.: PCT/EP2023/073133

§ 371 Date: Feb. 27, 2025

(30) Foreign Application Priority Data
Aug. 31, 2022 (EP) 22193223.9

(51) Int. Cl. A63G 21/18; C08G 18/62; C09D 175/04

(52) U.S. Cl. CPC A63G 21/18; C08G 18/6225; C09D 175/04

(57) ABSTRACT

The present invention relates to the use of a water-based two-component polyurethane resin that is applied to a waterslide at a thickness of at least 3 μm, but less that 100 μm as a first-time application to new waterslides and for maintaining and repairing existing waterslides.

### FIELD OF THE INVENTION

The present invention relates to the use of a polyurethane coating for the improvement, maintenance and repair of waterslides.

### PRIOR ART

The sliding surface of standard plastic water slides, also known as the water surface side, is finished with a layer of what is known as a “gel coat”. These layers are available in a wide range of finishes and surface qualities. The term “gel coat” is used in a somewhat vague manner as a synonym for a variety of different coatings. The surfaces usually consist of a polymer layer. The latter can be based on epoxy, acrylate or polyurethane. In their written warranty conditions, the manufacturers specify that the surfaces should be regularly provided with a protective wax coating, depending on the level of use. It is recommended that the wax layer be renewed every one to three months. As with motor vehicles, hard wax is used, which has to be polished subsequently.

In addition to the wax layer for ongoing maintenance, there is the option of completely renewing the gelcoat. This is usually done in a very aggressive manner. The existing coating is heavily sanded (roughened) to ensure a good bond later on. This renewal is carried out with a very thick layer (»500 μm) of gelcoat, or in some cases even with new glass fibers as well.

The sliding surface of a waterslide is subjected to abrasive wear by sliding and especially by the flowing water. If the surfaces are not rewaxed soon enough and/or not often enough, abrasion will cause rough surfaces. The abrasion can even completely wear down or remove the gelcoat layer, exposing the structure's supporting reinforcement (usually fiberglass). At the latest in this state, the gelcoat layer must be renewed in order to continue the safe use of the waterslide, and further waxing would no longer provide a lasting smoothing effect.

Regular waxing to fulfill the conditions for maintaining the warranty claims and the necessary operating conditions, and to take into account the lifespan of the entire slide, means a great deal of work for the operator of the waterslides. Particularly during the season, the very laborious, work- and time-intensive procedure can lead to expensive downtimes. If the gel coat layer has to be renewed, every replacement or repair of the gel coat layer, apart from the basic effort, involves the risk of partial detachment of the gel coat layer, which poses a risk of cutting injuries to bathing guests sliding down. The gel coat applied in the mold during the production process of the slide body reacts chemically with the surface of the carrier material. It is difficult to restore the quality of this bond during repair work. In case the gelcoat is renewed, the gelcoat layer and often also the supporting structure (i.e. the actual body of the slide) are exposed to high stresses. In order to ensure a secure bond, a higher amount of (intact) gelcoat must regularly be removed during sanding than would be minimally necessary. In the long term, this can lead to damages to the actual tube. Renewing the gel coat is a time-consuming and costly process. The problem is often addressed too late by the operator or postponed, resulting in a further loss of quality of the slide and an ever-increasing repair effort.

The low abrasion resistance of wax and/or gel coat leads to a loss of the necessarily smooth surface after only a few weeks or months of slide use. This observation has been made even in indoor water parks, i.e. without exposure to environmental influences such as direct sunlight or wind. In heavily used water parks that are open all year round and exposed to the elements, abrasion develops even faster. The most extreme stresses arise when outdoor water slides are used in hot areas, such as in the Middle East (e.g. in Dubai, U.A.E.) and in the south of the USA (e.g. Nevada, California, Florida). In addition to extreme weather conditions (heat, UV radiation, temperature changes, etc.), there are often mechanically abrasive sandstorms, too.

Even without extreme outdoor conditions and despite regular waxing, the slide surfaces after only a short period of use generally show a pronounced microroughness that differs from the original state, which promotes the accumulation of finest particles and soiling. This soiling then leads to a further increase in roughness. The accumulations include, in particular, chlorides, (lime) salts, other finest particles or suspended matter from the water used (varies from region to region). The accumulations and soiling increase the frictional resistance, which reduces the sliding speed and, with so-called “water pressure acceleration” of sliding people in horizontal or ascending slide areas, requires higher pump capacities and thus a higher energy demand.

The resulting soiling, which, depending on the region, operating and environmental conditions, can occur after just a few weeks of operating a new slide, means that either the operator has to accept the soiling and the associated increased roughness or very aggressive cleaning agents have to be used for cleaning. As a last resort, the only option left is mechanical cleaning using abrasive methods (grinding). With shorter cleaning intervals and more intensive cleaning, wear increases and the service life of the slide is shortened.

If you compare the effort of waxing and, in particular, for re-applying the gel coat with the loss of earnings due to downtime, the balance is poor. This applies especially to water parks that are in operation throughout the year.

Newly applied gelcoat is also a wear layer. It has the same problems as the original coating in a new slide. Although longer service lives are achieved with greater layer thicknesses, the basic problem of low abrasion resistance is not solved.

Applying a gel coat without aggressive substrate preparation and without re-laying glass fiber to ensure bonding with the existing gel coat and/or the glass fiber generally does not work reliably. The thick layers that are technically necessary due to the low abrasion resistance of the coatings used so far often lead to spalling due to internal/bonding stresses in combination with a poor bond to the substrate.

The internal stresses are caused in combination with poor bonding between two materials that expand differently, as well as the dynamic stress when sliding and the thermal stress (day/night, summer/winter) of the slide.

There is therefore a high risk of injury to people sliding down the slide due to protruding, sharp-edged coating parts (of the gel coat) on an otherwise smooth surface.

### OBJECT OF THE INVENTION

Therefore, the object is to provide a coating for waterslides that remains durable for a period of at least 3-6 months without the risk of spalling, that can be applied and reworked quickly and easily, and allows for a more cost-effective, simpler and thus better maintenance and cleaning concept due to greater abrasion resistance.

### Solution to the Problem

This object is achieved by using a water-based two-component polyurethane resin (referred to in the following as “2K-PUR”), which is applied in thin layer thicknesses («100 μm) to a waterslide. The polyurethane resin is water-dilutable, highly cross-linked and resistant to solvents when fully cured. It is characterized by a pronounced chemical resistance and very good abrasion resistance. Thin layers («100 pm) have a lower risk of adhesion failure between the slide material and the applied coating. In the event of an adhesion failure, the risk of injury is lower with a thin layer than with brittle “thick coatings”.

The 2K-PUR is formed by a resin component A and a hardener component B. The resin component (A) preferably contains, in addition to water, an anionic polyacrylate dispersion, an anti-foaming agent, a silicone surfactant, a polyacrylate-based surface additive, a catalyst (e.g. a zinc amine complex) and a rheology modifier (in particular a hydrophobically modified ethoxylated urethane). The hardener component (B) is preferably a polyisocyanate, in particular a hydrophilic aliphatic polyisocyanate based on hexamethylene diisocyanate (HDI).

The two-component polyurethane resin can be colorless or colored. It can be matt or glossy for both alternatives. A colored 2K-PUR can be used in particular for the repair and maintenance of correspondingly colored waterslides.

The 2K-PUR can also contain particles, preferably nanoparticles, which are made of ceramic or glass, for example. These particles are suitable for filling in imperfections in the existing gel coat on the waterslide surface and are also useful because they have a very high abrasion resistance. The particle size is determined by the layer thickness of the 2K-PUR applied to the waterslide. If a coating of only a few micrometers is to be applied, the particles must also be correspondingly small; if a coating of almost 100 μm is to be applied, the particles can also be correspondingly large.

“Abrasion resistance” is characterized by the avoidance or reduction of abrasive wear. “Abrasion” refers to the loss of material that occurs, among other things, as a result of the mechanical action of one rubbing partner on the other or through a flowing medium. Particles that are released from the material in this respect are called abrasion. The abrasion resistance can be determined by various methods, e.g. by means of a scrub test.

According to the invention, the layer thickness is less than 100 μm but more than 3 μm. Advantageously, the layer thickness is between 5 and 90 μm, preferably between 10-20 and 85 μm, most preferably between 30 and 80 μm, more preferably around 75 μm. During initial treatment, layer thicknesses of 3-10 μm, preferably around 5 μm, are desirable.

In a preferred embodiment, the two-component polyurethane resin is the “porviva WSC050” that can be purchased from specialist retailers and is characterized by the following formulation and the following properties:

| | porviva WSC050 | |
|---|---|---|
| | transparent gloss | |
| | A component (resin) | Parts by weight |
| Pos. | Glossy, MR = 5:1 | per 100 g |
| 1 | Bayhydrol ® A 2542 | 50.00 |
| 2 | Byk 011 | 2.50 |
| 3 | Byk 345 | 0.30 |
| 4 | BYK 3441 | 0.50 |
| 5 | K-Kat XK-661 | 0.30 |
| 6 | De-ionized water | 44.40 |
| 7 | Rheovis ® PU 1214 | 2.00 |
| | Sum | 100.00 |

| | porviva WSC050 | |
|---|---|---|
| | transparent gloss | Parts by weight |
| Pos. | B component (hardener) | per 100 g |
| 1 | Bayhydur ® XP 2547 | 20.00 |

The delivered mixture with an active ingredient content of approx. 60% can be diluted with up to 5 parts of water. This results in a variation of the active ingredient content of approx. 5% to approx. 60% in the aqueous solution for flexible adjustment of the layer thickness, i.e. the coating can be used as a first-time application when the waterslide is delivered or as a later basic protection (with little water addition «100 μm) and as an initial treatment/wear layer (with high water addition 3-10 μm, preferably about 5 μm (3/up to 1:5 diluted with water). Due to the high level of cross-linking of the product, this results in better abrasion resistance and cleanability.

Furthermore, the substrate preparation must be performed in a less abrasive manner. It has proven to be advantageous to carefully sand the substrate or, better yet, to blast it with suitable methods in order to remove a smaller amount of intact layer thicknesses. Otherwise, the removal of colored gelcoat, which was applied at the factory during the manufacture of the waterslide, can result in the exposure of glass fiber. Abrasive blasting can prepare the surface evenly at both elevated and low-lying areas, whereas grinding only mechanically wears away the elevated areas. To complete a substrate preparation, the elevated areas must be removed down to the low-lying areas. Abrasive blasting achieves a higher roughness for a better mechanical bond of the 2K-PUR to be applied according to the invention. This targeted substrate preparation also results in less damage to the substrate and adhesion-reducing particles are removed. According to the invention, “abrasive blasting” is therefore understood to mean a mechanical surface treatment with blasting agents in which the surface is bombarded with granular materials of different shapes and sizes. The granular material has an increased relative speed with regard to the surface given by external influence. This speed is imparted to the grain either by throwing or by a flowing carrier medium. When throwing, the grain is grasped by rotating arms of a spinning wheel. When transported by a transport medium, the latter first acquires kinetic energy via pumps or compressors before the grain is introduced into the transport medium. In general, air or water can be used as transport media (wet blasting). The accelerated grain then hits the rough surface of a workpiece, where it is intended to perform a chip-removing function. The blasting effect varies depending on the size ratio between the roughness of the surface and the grain size of the blasting agent. It is also possible to use dry ice blasting. Dry ice blasting is a compressed air blasting process in which solid carbon dioxide, so-called dry ice, with a temperature of around −79 C, is used as the blasting agent.

The technical benefit of the invention is that the coating applied according to the invention extends the service life of the factory-applied gel coat better than waxing. Furthermore, the coating allows for quick reworking even with partial wear of the coating (initial treatment), which means that more cost-intensive repairs and/or new investments will be required later.

The initial treatment (layers of approx. 3 to 10 μm (2-PUR diluted with water up to 1:5)) can be used at shorter intervals for easy reworking of surfaces that are already dull or rough. For the “initial treatment”, only a light cleaning with pressurized water and, if necessary, with the addition of cleaning pads and light chemical cleaners is required, as well as the application of very thin 2-PUR layers. Only small scratches and micro-voids should be filled up and repaired locally during the initial treatment. A smooth and even surface with low frictional resistance is thus restored. Should the initial treatment show insufficient adhesion on the still even and intact surface areas, the success of the remaining repair work would still be ensured. Loose, non-adherent “initial treatment layers” (with a layer thickness of approx. 3 to 10 μm) are neither a defect nor a restriction on use.

Longer runtimes lead to an increase in the durability and longevity of the entire slide. Since the coating is only thin, no coarse spalling areas can occur, which prevents accidents with cut injuries. It also generates low friction, which has a positive effect on the pump power required and thus lower energy consumption for operation.

The following example is intended to explain the invention, but does not limit it to the exact embodiment.

### EXAMPLE 1

The commercially available “porviva WSC050” (“transparent gloss”, “transparent matt” or “color gloss” (desired color)), which contains component A (resin) and component B (hardener) in the correct ratio, is used as the two-component PUR coating. Component B must be completely emptied into the container of component A. To achieve a homogeneous consistency and intensive mixing, the two components must be thoroughly mixed with a suitable slow-running agitator at approx. 300 rpm. The bottom and edge areas of the mixing vessel must also be included. The mixing process must be carried out until a homogeneous, streak-free state is obtained, but for at least 3 minutes. Preferably, do not process the material from the delivery container afterwards, but sieve it and decant it into a clean container and mix again for about 1 minute. The temperature of the two components should be between 1° and 45° C. when mixing, preferably between 15 and 25° C.

After mixing, “porviva WSC050” is applied from a roller tray with a run-off surface using a cross-coat method. The best results are achieved with a solvent-resistant, lint-free painting roller with 6-7 mm pile. The application can also be done by spraying. Connection areas should be finished after 8-10 minutes at the latest, otherwise roller marks might become visible. The application on a standard water slide is done in a thickness of 80 μm.

Two-component epoxy resins are used as gelcoats 1 and 2 and are also applied in the appropriate thickness.

The materials are defined in more detail in the following table.

| | Resin | Hardener |
|---|---|---|
| Description | component | component |
| 2K PUR | Component A of porviva | Component B of porviva |
| MR 100:20 in | WSC050 (s. above) | WSC050 (s. above) |
| parts by weight | | |
| Gelcoat 1 | 1-methylethylidene)bis(4,1- | Benzyl alcohol 50% |
| | phenylene oxymethylene)] | |
| MR 100:50 in | bisoxirane 75% | |
| parts by weight | Bisphenol-F-epichlorohydrin | 3-Aminomethyl-3,5,5- |
| | resin 25% | trimethyl-cyclohexylamine |
| | | 20% |
| | | Cyclohexanemethanamine,5- |
| | | amino-1,3,3-trimethyl-, |
| | | reaction product with |
| | | Bisphenol A diglycidyl ether |
| | | homopolymer 10% |
| | | Polypropylene diamine 5% |
| | | 2,4,4)-Trimethyl-1,6-diamine |
| | | 5% |
| | | Phenol, 4,4′-(1- |
| | | methylethylidene)bis-, |
| | | polymer with 2- |
| | | (chloromethyl)oxirane, |
| | | reaction product with |
| | | 2,2,4(or2,4,4)-trimethyl-1,6- |
| | | hexanediamine 10% |
| Gelcoat 2 | Bisphenol F-epichlorohydrin | Phenol, styrenated 30% |
| | resins 60% | |
| MR 100:50 in | Bisphenol A- | 2,2,4-Trimethylhexane-1,6- |
| parts by weight | epichlorohydrin resins 25% | diamine 40% |
| | 1,6-Bis(2,3-epoxy- | Phenol, methyl-styrenated |
| | propoxy)hexane 15% | 20% |
| | Solvent: naphtha 10-25% | Salicylic acid 10% |

In the following, the wet abrasion resistance is tested by a standard “scrub test according to DIN EN 13300:2002-11 (Paints and varnishes-water-based paints and varnishes and coating systems for interior walls and ceilings-classification; German version EN 13300:2001+AC: 2002).

Wet Scrub Resistance-Test Results after 200, 400, 600 and 800 Scrub Cycles

| | Wet abrasion [μm] after | | | | | | Requirement |
|---|---|---|---|---|---|---|---|
| | 200 | 400 | 600 | | 800 | | after 200 |
| | cycles | cycles | cycles | | cycles | | cycles |
| 2k PUR | 3.0 μm | 3.5 μm | 3.7 | μm | 4.2 | μm | <5.0 μm |
| water-based | | | | | | | |
| Gelcoat 1 | 4.2 μm | 4.9 μm | 50.0 | μm | 1000.0 | μm | <5.0 μm |

| (2K epoxy) | | | | | | |
|---|---|---|---|---|---|---|
| Gelcoat 2 | 4.5 μm | 8.0 μm | 1000.0 | μm | — | <5.0 μm |

(2K epoxy)

1000.0 μm = test film completely destroyed

The table above shows that even after 800 abrasion cycles, the 2K PUR coating applied according to the invention is still almost completely present. By contrast, the gelcoats applied for comparison have been completely removed.

1. Use of a water-based two-component polyurethane resin, which is applied as a coating to the surface of a waterslide at a thickness of at least 3 μm but less than 100 μm, for the first-time application, maintenance and repair of waterslides.

2. The use according to claim 1, wherein the application thickness for the first-time application and repair is between 20 and 80 μm, preferably around 75 μm.

3. The use according to claim 1, wherein the application thickness for the initial treatment is between 3 and 10 μm, preferably around 5 μm.

4. The use according to claim 1, wherein the two-component polyurethane resin contains particles of ceramic or glass.

5. The use according to claim 1, wherein the waterslide is prepared for the application of the coating by blasting off the previous surface coating.

6. The use according to claim 5, wherein the abrasive blasting is carried out by a mist blasting method, wet blasting, dry ice blasting or grinding.

7. The use according to claim 1, wherein the two-component polyurethane resin is formed by a resin component A and a hardener component B, the resin component A containing an anionic polyacrylate dispersion, an anti-foaming agent, a silicone surfactant, a polyacrylate-based surface additive, a catalyst and a rheology modifier, and the hardener component B contains a polyisocyanate.

8. The use according to claim 7, wherein the hardener component B is a hydrophilic aliphatic polyisocyanate based on hexamethylene diisocyanate (HDI).
